(19) United States
(12) Patent Application Publication
(10) Pub. No.: US 2008/0222931 A1
(43) Pub. Date: Sep. 18, 2008

(54) DISPLAY DEVICE FOR GOLF CLUB PROTECTOR

(76) Inventor: Chiawen Wu, Richmond (CA)

Correspondence Address: MATTHIAS SCHOLL, 14781 MEMORIAL DRIVE, SUITE 1319, HOUSTON, TX, 77079, US

(21) Appl. No.: 11/837,691

(22) Filed: Aug. 13, 2007

(30) Foreign Application Priority Data
Mar. 13, 2007 (CN) 200720118908.8

(51) Int. Cl. A63B 57/00; G09F 11/02

(52) U.S. Cl. 40/493; 473/407; 150/160

(57) ABSTRACT

The invention teaches a tumble marker indicator for golf club protector, comprising an enclosure having a marker display window and a connective device to engage with the golf club protector; a rotation wheel that can be rotated intermittently and a rotating shaft engaged with the rotation wheel are set inside of the enclosure; a tumbling apparatus connected to the rotation wheel is set at one side of the rotation wheel; a non-return apparatus to avoid the back rotation of the rotation wheel is set at the other side of the rotation wheel; and a plurality of different markers distributed along the circumferential direction of the rotation wheel, which can be displayed orderly through the marker display window on the enclosure when rotating the rotation wheel intermittently. Since the display indicator of the invention for golf club protector is marked with a plurality of different numbers and symbols, the display marker can be changed easily according to demand, the function of displaying various numbers of commonly used golf clubs with one display indicator is realized, and the inconvenience of carrying a plurality of marker tags simultaneously is avoided.

### CROSS-REFERENCE TO RELATED APPLICATIONS

This application claims priority to Chinese Patent Application No. 200720118908.8 filed on Mar. 13, 2007, the contents of which are incorporated herein by reference.

### BACKGROUND OF THE INVENTION

1. Field of the Invention

This invention relates to a tumble marker indicator for a golf club protector, and more particularly, to a tumble marker indicator capable of changing the display marker according to demand.

2. Description of the Related Art

It is well known to those skilled in the art that a protector is generally used for protecting a golf club. When not in use, a golf club should be protected well as it is put into a protector, this especially being true for a costly wood, e.g., #1, #2, and #5 woods, and for a costly putter.

A conventional golf club protector comprises a head portion to protect the head of a golf club and a body portion to protect the shaft of a golf club. Generally, the head portion is knitted from a good flannel material, while the body portion is fabricated from an elastic material and is in a shape of an elongated cylinder.

When a golf club is secured in a protector, the head of the club is covered completely and the identifying number of the club is not visible making club selection difficult during play. Therefore, some protectors are permanently marked with markers on their outside. However, in this way, one protector can only be used for a specific club, and cannot be used for other clubs, which can be inconvenient.

Alternatively, some protectors are marked by a detachable marker tag. Although in this way, one protector can be used for different types of clubs by replacing one marker tag with another, it is also inconvenient to carry many sets of marker tags.

### SUMMARY OF THE INVENTION

In view of the above-described problems, it is an objective of the invention to provide a marker indicator having more than one different indicia (e.g., numbers or symbols) for a golf club protector by means of which the display marker can be changed easily according to demand.

To achieve the above objective provided is a tumble marker indicator for a golf club protector, comprising an enclosure having a marker display window and a connective device serving to engage with the golf club protector; a rotation wheel capable of rotating intermittently and a rotating shaft engaged with the rotation wheel disposed inside of the enclosure; a tumbling apparatus connected with the rotation wheel set at one side of the wheel; a non-return apparatus serving to avoid the back rotation of the rotation wheel set at the other side of the rotation wheel; and a plurality of different markers distributed along the circumferential direction of the rotation wheel. When rotating the rotation wheel intermittently, the markers marked thereon can be displayed orderly through the marker display window of the enclosure.

In certain embodiments of the invention, the tumbling apparatus comprises a lever, a driving ratchet wheel, and a tumbling repositioning torsion-spring. The lever and the driving ratchet wheel are combined together. The lever is located in a slot having a certain oscillation stroke in the enclosure. The outer end of the lever is exposed out of the enclosure. The driving ratchet wheel is fitted on one end of the rotating shaft. The inner side of the driving ratchet wheel is engaged with the ratchets on the rotation wheel so as to drive the rotation wheel rotating intermittently. One end of the tumbling repositioning torsion-spring is fixed on the driving ratchet wheel. The other end of the tumbling repositioning torsion-spring is supported by the enclosure. An integral formed spring fixing column is formed on the driving ratchet wheel. One end of the tumbling repositioning torsion-spring is fixed on the spring fixing column, while the other end is supported by a limiting slot at the inner side of the enclosure.

In certain embodiments of the invention, the non-return apparatus comprises a non-return ratchet wheel fitted on one end of the rotating shaft. A keyway is formed on the peripheral edge of the non-return ratchet wheel, and is engaged into the keyway slot located on the enclosure to fix the non-return ratchet wheel circumferentially. Meanwhile, the inner side of the non-return ratchet wheel is engaged with the ratchets on the rotation wheel to avoid the back rotation of the rotation wheel.

In certain embodiments of the invention, the enclosure comprises a front cover and a back cover having a marker display window thereon. The front cover and the back cover are connected together through the engagement of a tenon with a tenon groove, and are bonded with one another by means of adhesives.

In certain embodiments of the invention, the connective device on the enclosure is a long hole for passing through a cloth strip to engage with the golf club protector.

As a result, since the display indicator of the invention for golf club protector is marked with a plurality of different numbers and symbols, the display marker can be changed easily according to demand, the function of displaying various numbers of commonly used golf clubs with one display indicator is realized, and the inconvenience of carrying a plurality of marker tags simultaneously is avoided.

### BRIEF DESCRIPTION OF THE DRAWINGS

FIG. 1 illustrates a front perspective view of the marker indicator according to one embodiment of the invention;

FIG. 2 illustrates a back perspective view of the marker indicator according to one embodiment of the invention;

FIG. 3 illustrates an exploded view of the marker indicator according to one embodiment of the invention;

FIG. 4 is a front elevational view of the front cover of the marker indicator according to one embodiment of the invention;

FIG. 5 is a A-A cross-sectional view of the front cover of FIG. 4 according to one embodiment of the invention;

FIG. 6 is a perspective view of the inner side of the front cover of FIG. 4 according to one embodiment of the invention;

FIG. 7 is a front elevational view of the back cover of the marker indicator according to one embodiment of the invention;

FIG. 8 is a B-B cross-sectional view of the back cover of FIG. 7 according to one embodiment of the invention;

FIG. 9 is a front elevational view of the inner side of the back cover of FIG. 7 according to one embodiment of the invention;

FIG. 10 is a right elevational view of the rotation wheel according to one embodiment of the invention;

FIG. 11 is a left elevational view of the rotation wheel according to one embodiment of the invention;

FIG. 12 is a C-C cross-sectional view of the rotation wheel of FIG. 10 according to one embodiment of the invention; and

FIG. 13 is a perspective view of the tumbling apparatus according to one embodiment of the invention.

### DETAILED DESCRIPTION OF THE INVENTION

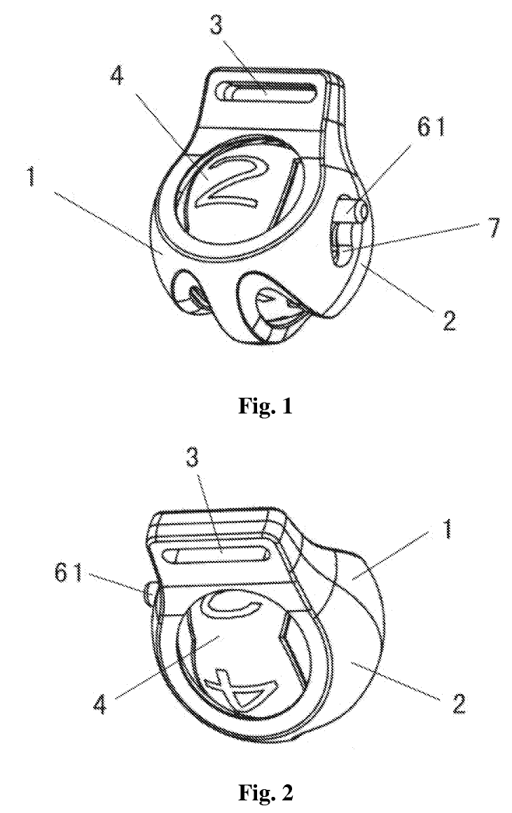

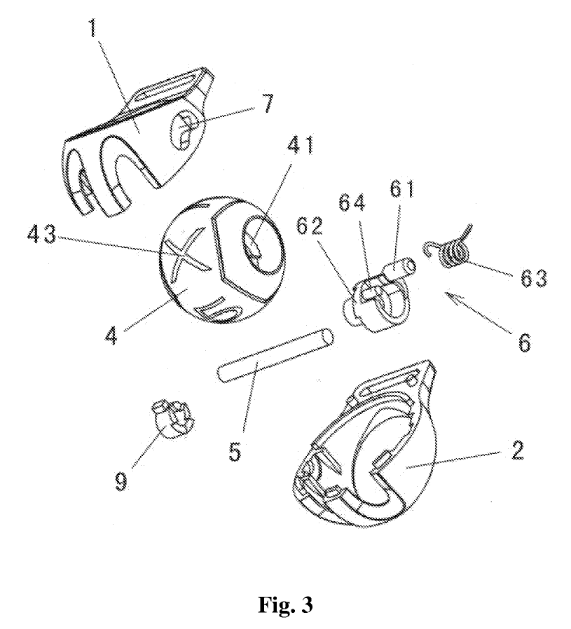

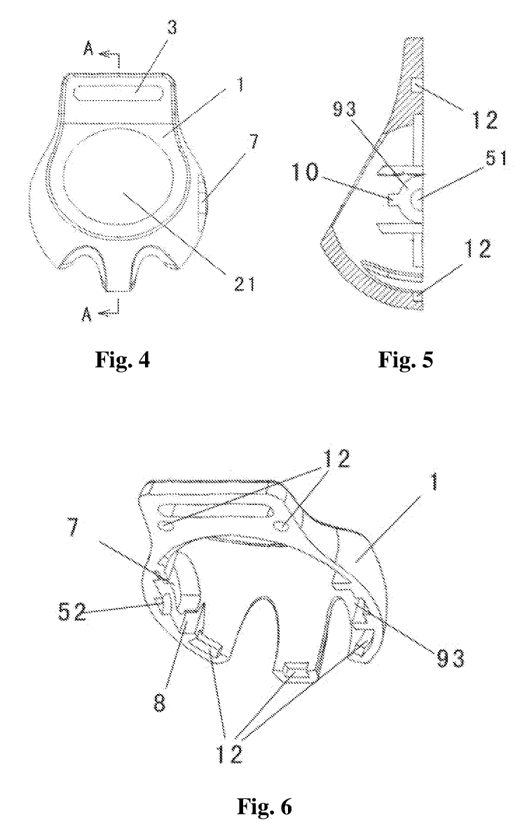

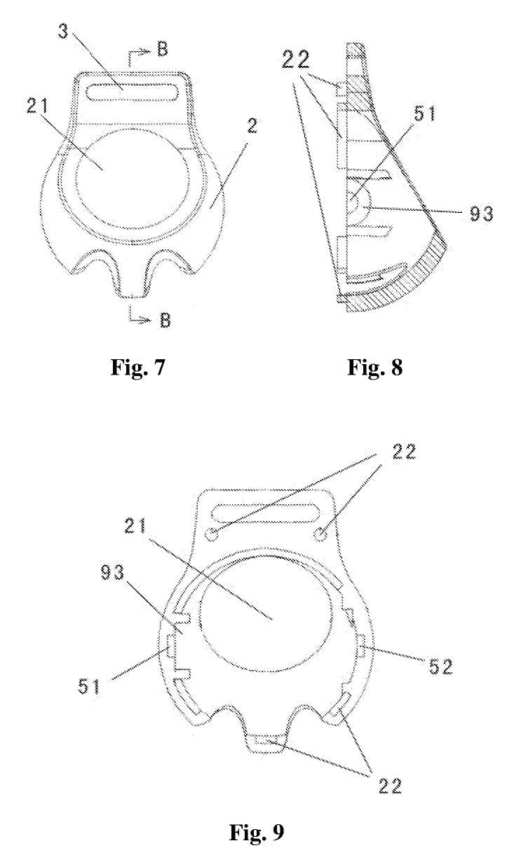

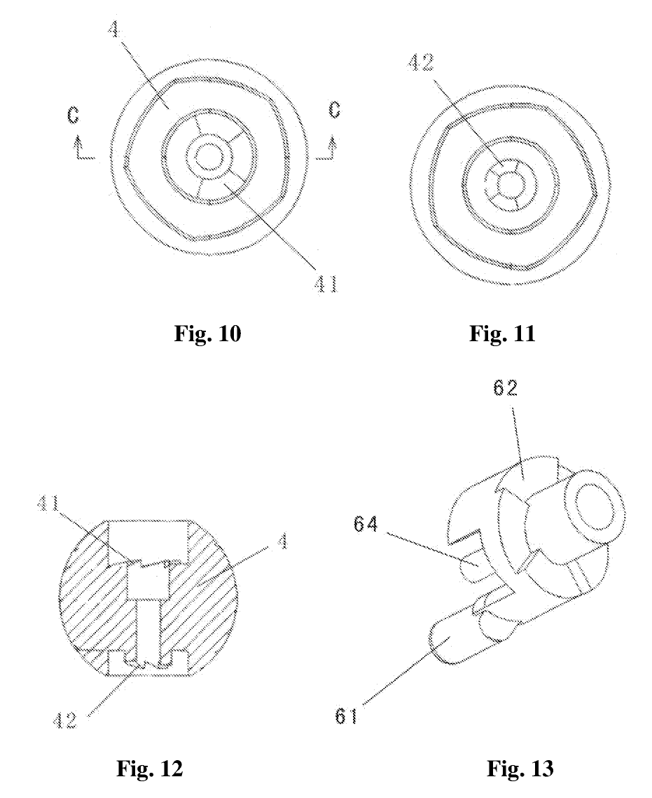

FIGS. 1-13 illustrate a tumble marker indicator for golf club protector in accordance with one embodiment of the invention, comprising an enclosure having a front cover 1 and a back cover 2. The front cover 1 and the back cover 2 are matched with each other, and have a marker display window 21. The front cover 1 and the back cover 2 are connected by the engagement of a tenon 22 on the back cover 2 with a tenon groove 12 on the front cover 1, and are bonded to each other by means of adhesives. A connective device that can be engaged with the golf club protector is formed on the top of the enclosure. Preferably, the connective device is a long hole for passing through a cloth strip to engage with the golf club protector.

In the present embodiment, a rotation wheel 4 capable of rotating intermittently and a rotating shaft 5 engaged with the rotation wheel 4 are located inside of the enclosure. The right end of the rotating shaft 5 is supported by a right shaft seat 52 at the inner side of the enclosure. A tumbling apparatus 6 connected to the rotation wheel 4 is disposed at one side of the rotation wheel 4, and is fitted on the right end of the rotating shaft 5.

The tumbling apparatus 6 comprises a lever 61, a driving ratchet wheel 62, and a tumbling repositioning torsion-spring 63. The lever 61 and the driving ratchet wheel 62 are combined together. The lever 61 is located in a slot 7 having a certain oscillation stroke in the enclosure. The outer end of the lever 61 is exposed out of the enclosure. The driving ratchet wheel 62 is fitted on the rotating shaft 5. The inner side of the driving ratchet wheel 62 is engaged with the right ratchet 41 on the rotation wheel 4 to drive the rotation wheel 4 rotating intermittently. One end of the tumbling repositioning torsion-spring 63 is fixed on the spring fixing column 64 on the driving ratchet wheel 62, while the other end is supported by the limiting slot 8 located at the inner side of the enclosure.

A non-return apparatus 9 to avoid the back rotation of the rotation wheel 4 is disposed at the other side of the rotation wheel 4, and is fitted on the left end of the rotating shaft 5. The non-return apparatus 9 comprises a non-return ratchet wheel 91 located in a groove 93 formed on the inner surface of the enclosure. A left shaft seat 51 to support the left end of the rotating shaft is further set inside of the groove 93. A keyway 92 is formed at the peripheral edge of the non-return ratchet wheel 91, and is engaged with the keyway slot 10 located at one side of the groove 93 to limit the circumferential rotation of the non-return ratchet wheel 91. Meanwhile, the inner side of the non-return ratchet wheel 91 is geared with the left ratchets on the rotation wheel 4 to limit the back rotation of the rotation wheel 4.

A plurality of different markers 43 is distributed on the circumferential direction of the rotation wheel 4. When rotating the rotation wheel 4 intermittently, the marker 43 thereon can be displayed orderly through the marker display window 21 on the enclosure, and only one marker can be displayed on each marker display window every time.

At an initial stage, the lever 61 is located on top of the slot 7 of the enclosure. The outer end of the lever 61 is exposed out of the slot 7. Since the tumbling apparatus 6 is equipped with a tumbling repositioning torsion-spring 63, and one end of the tumbling repositioning torsion-spring 63 is fixed on the spring fixing column 64 of the driving ratchet wheel 62, the other end is supported by the limiting slot 8 at the inner side of the enclosure. Therefore, the torsion force of the spring 63 must be overcome when tumbling the lever 61 downward.

When tumbling the lever 61 downward, the driving ratchet wheel 62 rotates along with the lever 61, and the inner side of the driving ratchet wheel 62 is geared with the right ratchets of the rotation wheel 4 to drive the rotation wheel rotating synchronously. When the lever 61 is tumbled to the lower end of the slot 7, the rotation wheel 4 is rotated exactly to a position to display the next marker. At this time, releasing the lever 61, the driving ratchet wheel 62 rotates backward to its initial position under the function of the torsion force of the tumbling repositioning torsion-spring 63, and the lever 61 moves to the upper end of the slot 7 accordingly. During the back rotation of the driving ratchet wheel 62, its inner side slides through, instead of being geared with, the right ratchets of the rotation wheel 4. Meanwhile, since the non-return ratchet wheel 91 is disposed at the left side of the rotation wheel 4, the rotation wheel is kept in place. By repeating the above process, the rotation wheel can be rotated about a certain angle to display a specific marker.

While particular embodiment of the invention has been shown and described, it will be obvious to those skilled in the art that changes and modifications may be made without departing from the invention in its broader aspects, and therefore, the aim in the appended claims is to cover all such changes and modifications as fall within the true spirit and scope of the invention.

What is claimed is:

1. A tumble marker indicator for golf club protectors, comprising
an enclosure having a marker display window and a connective device to engage with the golf club protector,
a rotation wheel that can be rotated intermittently and a rotating shaft engaged with the rotation wheel set inside of the enclosure;
a tumbling apparatus connected to the rotation wheel disposed at one side of the rotation wheel;
a non-return apparatus to avoid the back rotation of the rotation wheel disposed at the other side of the rotation wheel; and
a plurality of different markers distributed along the circumferential direction of the rotation wheel;
wherein said markers are be displayed orderly through the marker display window on the enclosure when rotating the rotation wheel intermittently.

2. The indicator of claim 1, wherein
the tumbling apparatus comprises a lever, a driving ratchet wheel, and a tumbling repositioning torsion-spring;
the lever and the driving ratchet wheel are combined together;
the lever is located in a slot having a certain oscillation stroke in the enclosure;
the outer end of the lever is exposed out of the enclosure;
the driving ratchet wheel is fitted on one end of the rotating shaft;
the inner side of the driving ratchet wheel is engaged with the ratchets on the rotation wheel so as to drive the rotation wheel rotating intermittently;
one end of the tumbling repositioning torsion-spring is fixed on the driving ratchet wheel; and
the other end of the tumbling repositioning torsion-spring is supported by the enclosure.

3. The indicator of claim 2, wherein
an integral formed spring fixing column is formed on the driving ratchet wheel,
one end of the tumbling repositioning torsion-spring is fixed on the spring fixing column; and
the other end of the tumbling repositioning torsion-spring is supported by a limiting slot at the inner side of the enclosure.

4. The indicator of claim 1, wherein
the non-return apparatus comprises a non-return ratchet wheel fitted on one end of the rotating shaft;
a keyway is formed on the peripheral edge of the non-return ratchet wheel, and is engaged into the keyway slot located on the enclosure to fix the non-return ratchet wheel circumferentially; and
the inner side of the non-return ratchet wheel is engaged with the ratchets on the rotation wheel to avoid the back rotation of the rotation wheel.

5. The indicator of claim 1, wherein
the enclosure comprises a front cover and a back cover having a marker display window thereon;
the front cover and the back cover are connected together through the engagement of a tenon with a tenon groove, and
the front cover and the back cover are connected by means of adhesive.

6. The indicator of claim 2, wherein
the enclosure comprises a front cover and a back cover having a marker display window thereon;
the front cover and the back cover are connected together through the engagement of a tenon with a tenon groove, and
the front cover and the back cover are connected by means of adhesive.

7. The indicator of claim 3, wherein
the enclosure comprises a front cover and a back cover having a marker display window thereon;
the front cover and the back cover are connected together through the engagement of a tenon with a tenon groove, and
the front cover and the back cover are connected by means of adhesive.

8. The indicator of claim 4, wherein
the enclosure comprises a front cover and a back cover having a marker display window thereon;
the front cover and the back cover are connected together through the engagement of a tenon with a tenon groove, and
the front cover and the back cover are connected by means of adhesive.

9. The indicator of claim 1, wherein the connective device on the enclosure is a longitudinally-shaped hole for passing through a cloth strip to engage with the golf club protector.

10. The indicator of claim 2, wherein the connective device on the enclosure is a longitudinally-shaped hole for passing through a cloth strip to engage with the golf club protector.

11. The indicator of claim 3, wherein the connective device on the enclosure is a longitudinally-shaped hole for passing through a cloth strip to engage with the golf club protector.

12. The indicator of claim 4, wherein the connective device on the enclosure is a longitudinally-shaped hole for passing through a cloth strip to engage with the golf club protector.
